(19) United States
(12) Patent Application Publication
(10) Pub. No.: US 2025/0317223 A1
(43) Pub. Date: Oct. 9, 2025

(54) ELECTRONIC DEVICE AND METHOD FOR TRANSMITTING DATA TO WIRELESS EARPHONE BY MEANS OF EXTERNAL APPARATUS

(71) Applicant: Samsung Electronics Co., Ltd., Suwon-si (KR)

(72) Inventors: Janghyun NAM, Suwon-si (KR); Hyoseok NA, Suwon-si (KR)

(21) Appl. No.: 18/986,005

(22) Filed: Dec. 18, 2024

Related U.S. Application Data
(63) Continuation of application No. PCT/KR2023/008880, filed on Jun. 26, 2023.

(30) Foreign Application Priority Data
Jun. 28, 2022 (KR) 10-2022-0079059
Jul. 26, 2022 (KR) 10-2022-0092621

(51) Int. Cl. H04B 17/318; H04R 1/10

(52) U.S. Cl. CPC H04B 17/318; H04R 1/1041; H04R 2420/07

(57) ABSTRACT

An electronic device is provided. The electronic device includes a communicator configured to establish communication with wireless earphones, memory storing one or more computer programs, and a processor communicatively coupled to the communicator and the memory, wherein the one or more computer programs include computer-executable instructions that, when executed by the processor individually or collectively, cause the electronic device, cause the electronic device to periodically measure a first received signal strength power of wireless earphones with respect to the electronic device and a number of first data transmissions from the electronic device to the wireless earphone, transmit, to an external device, target data to be transmitted to the wireless earphone, and, when the measured first received signal strength power decreases to a first threshold value or below or a measured number of first data transmissions increases to a first threshold number or above, terminate communication between the electronic device and the wireless earphone and control the external device to establish communication between the external device and the wireless earphone such that the wireless earphones receive the target data from the external device.

### CROSS-REFERENCE TO RELATED APPLICATION(S)

This application is a continuation application, claiming priority under § 365 (c), of an International application No. PCT/KR2023/008880, filed on Jun. 26, 2023, which is based on and claims the benefit of a Korean patent application number 10-2022-0079059, filed on Jun. 28, 2022, in the Korean Intellectual Property Office, and of a Korean patent application number 10-2022-0092621, filed on Jul. 26, 2022, in the Korean Intellectual Property Office, the disclosure of each of which is incorporated by reference herein in its entirety.

### BACKGROUND

### 1. Field

The disclosure relates to an electronic device for transmitting data to wireless earphones via an external device and a method thereof.

### 2. Description of Related Art

Recently, many efforts have been made to ensure high-quality audio performance in wireless earphones. The audio performance of the wireless earphones is ensured using various codecs, such as subband codec (SBC), which is a Bluetooth standard, advanced audio codec (AAA), proprietary Samsung scalable codec (SSC), low complexity communication codec (LC3), which is a standard of low energy (LE) audio, and lossless codec. The amount of data transmitted to the wireless earphones gradually increases to improve the audio quality. Due to this, a transmission control protocol (TCP) throughput and ensuring a stable electric field are significantly important, and techniques to transmit data with improved antenna performance, an additional antenna, and an improved TCP throughput have been studied. However, an improvement by an antenna has a limitation. Currently, in most electronic devices, one Bluetooth antenna is disposed and in some high-specification electronic devices, two Bluetooth antennas are disposed to support a dual Bluetooth dual mode. In this case, an electric field may be rapidly degraded according to an occurrence of a death grip phenomenon due to a type of gripping an electronic device by a user or a position of the electronic device (e.g., positioned around a metallic object that blocks a Bluetooth antenna), and thereby, the Bluetooth antenna may be significantly affected and the audio performance of the wireless earphones in which the communication is connected via Bluetooth may be degraded, and the TCP throughput may be restricted as an increase in data transmissions from the electronic device to the wireless earphones. Furthermore, a disconnection phenomenon may occur when the user of the electronic device listens to audio or calls through the wireless earphones. In addition, a stable electric field may be a significantly important factor to use the lossless codec in which the data to be transmitted to the wireless earphones increases. However, if the electric field condition of the electronic device with respect to the wireless earphones is unstable, it may be difficult to use the lossless codec.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for transmitting data to wireless earphones via an external device and a method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a communicator configured to establish communication with wireless earphones, memory storing one or more computer programs, and a processor communicatively coupled to the communicator and the memory, wherein the one or more computer programs include computer-executable instructions that, when executed by the processor individually or collectively, cause the electronic device to periodically measure a first received signal strength power of the wireless earphones with respect to the electronic device and a number of first data transmissions from the electronic device to the wireless earphones, transmit, to an external device, target data to be transmitted to the wireless earphones, when the measured first received signal strength power decreases to a first threshold value or below or a measured number of first data transmissions increases to a first threshold number or above, terminate communication between the electronic device and the wireless earphones and control the external device to establish communication between the external device and the wireless earphones such that the wireless earphones receive the target data from the external device.

In accordance with another aspect of the disclosure, an electronic device is provided. The electronic device includes a communicator configured to receive real-time data from an external network and transmit the real-time data to wireless earphones, memory storing one or more computer programs, and a processor communicatively coupled to the communicator and the memory, wherein the one or more computer programs include computer-executable instructions that, when executed by the processor individually or collectively, cause the electronic device to periodically measure fourth received signal strength power of the electronic device with respect to the external network and a number of second data transmissions from the external network to the electronic device, and when the measured fourth received signal strength power decreases to a fourth threshold value or below or a measured number of second data transmissions increases to a fourth threshold number or above, terminate communication between the electronic device and the wireless earphones and control an external device to establish communication between the external device and the external network and communication between the external device and the wireless earphones such that the wireless earphones receive real-time data from the external device.

In accordance with another aspect of the disclosure, a method, performed by a processor, is provided. The method includes periodically measuring first received signal strength power of wireless earphones, in which communication with an electronic device is established, to the electronic device and a number of first data transmissions from the electronic device to the wireless earphones, transmitting, to an external device, target data to be transmitted to the wireless earphones, and when the measured first received signal strength power decreases to a first threshold value or below or a measured number of first data transmissions increases to a first threshold number or above, terminating communication between the electronic device and the wireless earphones and controlling the external device to establish communication between the external device and the wireless earphones such that the wireless earphones receive the target data from the external device.

In accordance with another aspect of the disclosure, a method, performed by a processor is provided. The method includes receiving real-time data from an external network and transmitting the real-time data to wireless earphones, periodically measuring fourth received signal strength power of an electronic device to the external network and a number of second data transmissions from the external network to the electronic device, and when the measured fourth received signal strength power decreases to a fourth threshold value or below or a measured number of second data transmissions increases to a fourth threshold number or above, terminating communication between the electronic device and the wireless earphones and controlling an external device to establish communication between the external device and the external network and communication between the external device and the wireless earphones such that the wireless earphones receive real-time data from the external device.

In accordance with another aspect of the disclosure, one or more non-transitory computer-readable storage media storing computer-executable instructions that, when executed by a processor individually or collectively, cause the processor to perform operations are provided. The operations include periodically measuring first received signal strength power of wireless earphones, in which communication with an electronic device is established, to the electronic device and the number of first data transmissions from the electronic device to the wireless earphones, transmitting, to an external device, target data to be transmitted to the wireless earphones, and when the measured first received signal strength power decreases to a first threshold value or below or a measured number of first data transmissions increases to a first threshold number or above, terminating communication between the electronic device and the wireless earphones and controlling the external device to establish communication between the external device and the wireless earphones such that the wireless earphones receive the target data from the external device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a flowchart illustrating operations of an electronic device to terminate communication between the electronic device and wireless earphones and connect communication between an external device and wireless earphones according to an embodiment of the disclosure;

FIGS. 3 and 4 are diagrams illustrating a process of an electronic device to terminate communication between the electronic device and wireless earphones and connect communication between an external device and wireless earphones such that the external device receives target data from the electronic device and transmits the target data to the wireless earphones, according to various embodiments of the disclosure;

FIG. 5 is a flowchart illustrating a process of an electronic device to connect communication between an external device and wireless earphones and then reconnect communication between the electronic device and the wireless earphones, according to an embodiment of the disclosure;

FIG. 6 is a diagram illustrating communication connection among an electronic device, an external device, and wireless earphones according to an embodiment of the disclosure;

FIGS. 7 and 8 are diagrams illustrating a process of an electronic device to terminate communication between the electronic device and wireless earphones and connect communication between an external device and wireless earphones such that the external device receives real-time data from a network and transmits the real-time data to the wireless earphones, according to various embodiments of the disclosure;

FIG. 9 is a flowchart illustrating a process of an electronic device to connect communication between an external device and an external network and then reconnect communication between the electronic device and the external network, according to an embodiment of the disclosure; and

FIG. 10 is a diagram illustrating communication connection among an electronic device, an external device, wireless earphones, and a network according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

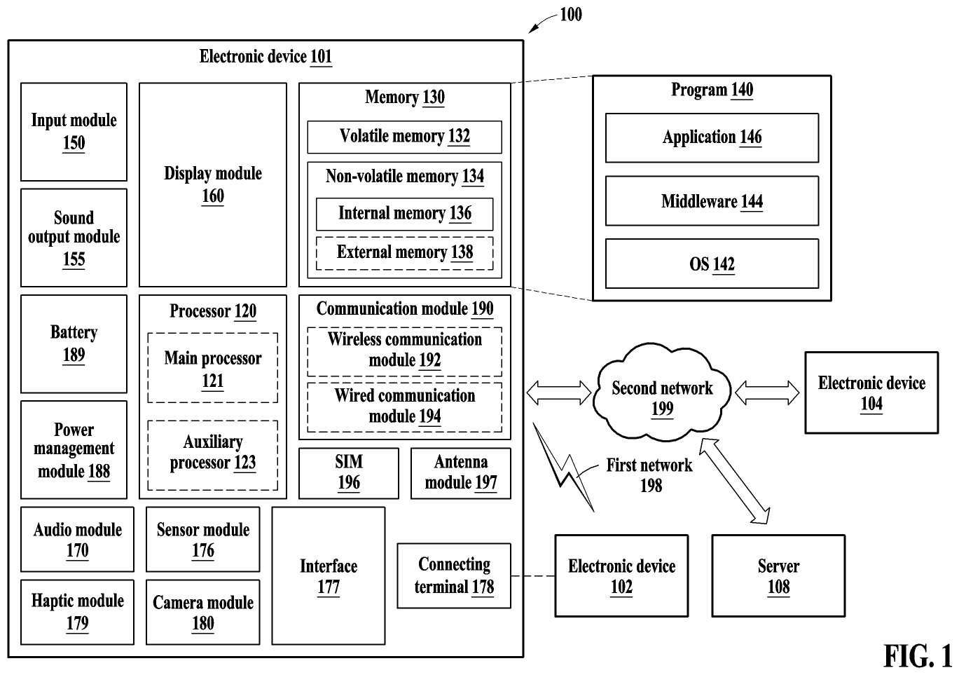

FIG. 1 is a block diagram of an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or communicate with an external electronic device 104 or a server 108 via a second network 199 (e.g., a long-range wireless communication network). According to an embodiment of the disclosure, the electronic device 101 may communicate with the external electronic device 104 via the server 108. According to one embodiment of the disclosure, the electronic device 101 may include a processor 120, memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one (e.g., the connecting terminal 178) of the above components may be omitted from the electronic device 101, or one or more other components may be added to the electronic device 101. In some embodiments of the disclosure, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to one embodiment of the disclosure, as at least a part of data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to one embodiment of the disclosure, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., a sleep) state or along with the main processor 121 while the main processor 121 is an active state (e.g., executing an application). According to one embodiment of the disclosure, the auxiliary processor 123 (e.g., an ISP or a CP) may be implemented as a portion of another component (e.g., the camera module 180 or the communication module 190) that is functionally related to the auxiliary processor 123. According to one embodiment of the disclosure, the auxiliary processor 123 (e.g., an NPU) may include a hardware structure specified for artificial intelligence (AI) model processing. An artificial intelligence model may be generated through machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134. The non-volatile memory 134 may include internal memory 136 and external memory 138.

The program 140 may be stored as software in the memory 130 and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to one embodiment of the disclosure, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to one embodiment of the disclosure, the display module 160 may include a touch sensor adapted to sense a touch, or a pressure sensor adapted to measure an intensity of a force incurred by the touch.

The audio module 170 may convert a sound into an electrical signal or vice versa. According to one embodiment of the disclosure, the audio module 170 may obtain the sound via the input module 150 or output the sound via the sound output module 155 or an external electronic device (e.g., the external electronic device 102, such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to one embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., by wire) or wirelessly. According to one embodiment of the disclosure, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the external electronic device 102). According to one embodiment of the disclosure, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to one embodiment of the disclosure, the haptic module 179 may include, for example, a motor, a piezoelectric element, or an electric stimulator.

The camera module 180 may capture a still image and moving images. According to one embodiment of the disclosure, the camera module 180 may include one or more lenses, image sensors, ISPs, or flashes.

The power management module 188 may manage power supplied to the electronic device 101. According to one embodiment of the disclosure, the power management module 188 may be implemented as, for example, at least a part of a power management integrated circuit (PMIC).

The battery 189 may supply power to at least one component of the electronic device 101. According to one embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more CPs that are operable independently from the processor 120 (e.g., an AP) and that support a direct (e.g., wired) communication or a wireless communication. According to one embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the external electronic device 104), or a network system (e.g., the second network 199). According to one embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to one embodiment of the disclosure, the antenna module 197 may include an antenna including a radiating element including a conductive material or a conductive pattern formed in or on a substrate (e.g., a printed circuit board (PCB)). According to one embodiment of the disclosure, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to one embodiment of the disclosure, another component (e.g., a radio frequency integrated circuit (RFIC)) other than the radiating element may be additionally formed as a part of the antenna module 197.

According to one embodiment of the disclosure, the antenna module 197 may form a mmWave antenna module. According to one embodiment of the disclosure, the mm Wave antenna module may include a PCB, an RFIC disposed on a first surface (e.g., a bottom surface) of the PCB or adjacent to the first surface and capable of supporting a designated a high-frequency band (e.g., a mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to one embodiment of the disclosure, commands or data may be transmitted or received between the electronic device 101 and the external electronic device 104 via the server 108 coupled with the second network 199. Each of the external electronic devices 102 and 104 may be a device of the same type as or a different type from the electronic device 101. According to one embodiment of the disclosure, all or some of operations to be executed by the electronic device 101 may be executed at one or more external electronic devices (e.g., the external electronic devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the result, with or without further processing the result, as at least part of a response to the request. To this end, cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to one embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

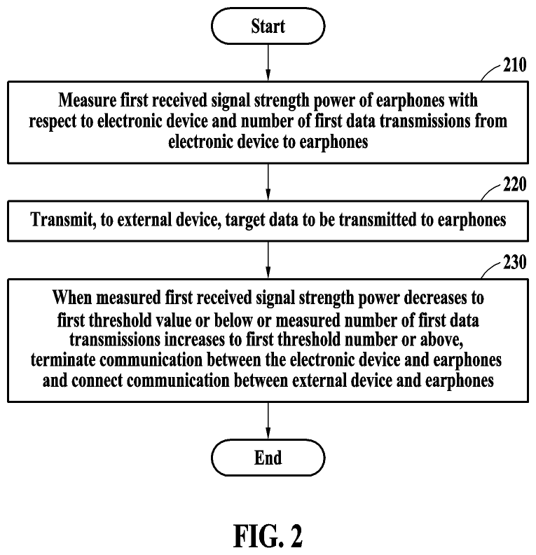

FIG. 2 is a flowchart illustrating operations of an electronic device to terminate communication between the electronic device and wireless earphones and connect communication between an external device and wireless earphones according to an embodiment of the disclosure.

Referring to FIG. 2, in operation 210, an electronic device (e.g., the electronic device 101 of FIG. 1) may periodically measure a first received signal strength power of wireless earphones with respect to the electronic device and the number of first data transmissions from the electronic device to the wireless earphones. The received signal strength power may indicate a value of power that a receiver receives. dBM may be used as a unit of received signal strength power and as the value increases, the strength power of a received signal may be strong. The number of data transmissions may indicate the number of transmissions of data by a transmitter to the receiver. For example, when the receiver fails to accurately decode data obtained from the transmitter, the receiver may transmit information to notify the transmitter of a decoding failure (e.g., negative acknowledgment (NACK)) to the transmitter to cause the transmitter to transmit the data again from a physical layer. When the receiver accurately decodes the data obtained from the transmitter, the receiver may transmit information to notify the transmitter of successful decoding (e.g., acknowledgment (ACK)) to the transmitter to cause the transmitter to transmit new data. The transmitter may calculate the number of transmissions of data before receiving the ACK from the receiver.

In operation 220, the electronic device may transmit, to an external device, target data to be transmitted to the wireless earphones. The electronic device may connect communication between the wireless earphones and the external device. The external device may be an electronic device, for example, a smartphone, a tablet personal computer (PC), a laptop, a wearable device, or the like, but is not limited thereto. The connection of communication may represent that data may be transmitted to or received from. The electronic device may transmit the target data to the wireless earphones while transmitting the target data to the external device. For example, the target data may be audio data.

In operation 230, when the measured first received signal strength power decreases to a first threshold value or below or the measured number of first data transmissions increases to a first threshold number or above, the electronic device may terminate the communication between the electronic device and the wireless earphones and may control the external device to connect communication between the external device and the wireless earphones such that the wireless earphones receive the target data from the external device. When the communication between the electronic device and the wireless earphones is not smooth, the electronic device may transmit the target data to the wireless earphones via the external device instead of directly transmitting the target data to the wireless earphones. For example, when second received signal strength power of the wireless earphones with respect to the external device is greater than the first received signal strength power of the wireless earphones with respect to the electronic device, the electronic device may cause the external device to transmit the target data to the wireless earphones instead of the electronic device such that the wireless earphones effectively receive the target data.

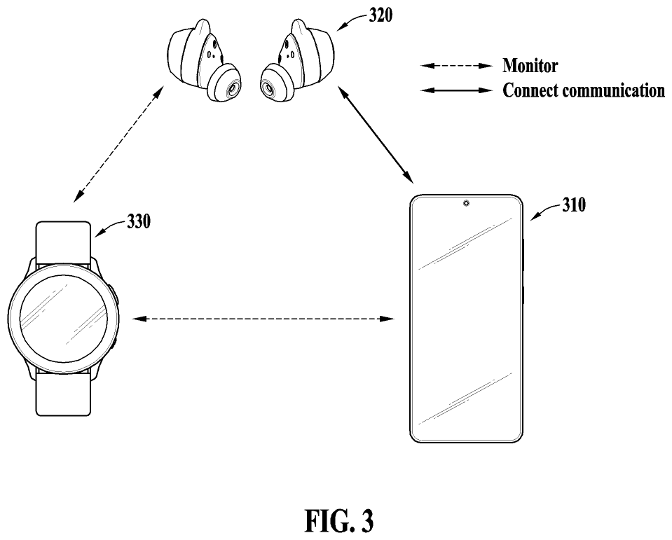

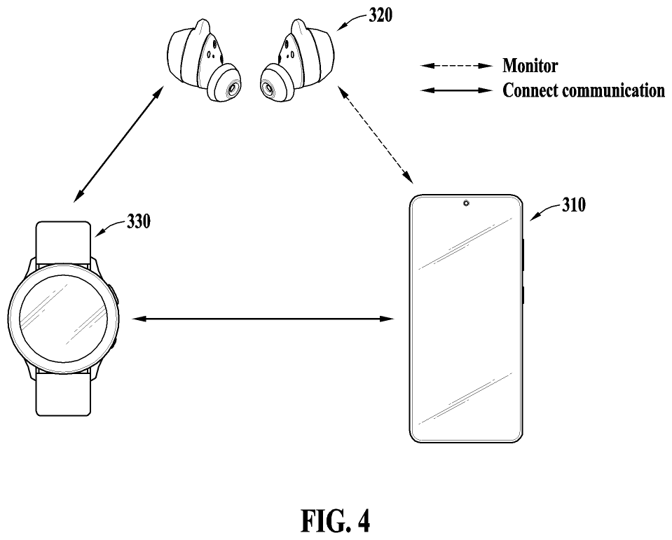

FIGS. 3 and 4 are diagrams illustrating a process of an electronic device to terminate communication between the electronic device and wireless earphones and connect communication between an external device and wireless earphones such that the external device receives target data from the electronic device and transmits the target data to the wireless earphones, according to various embodiments of the disclosure.

Referring to FIGS. 3 and 4, according to an embodiment of the disclosure, an electronic device 310 (e.g., the electronic device 101 of FIG. 1) may monitor an electronic device that may be connected to communicate with the electronic device 310. Referring to FIG. 3, the electronic device 310 may monitor an external device 330 disposed around the electronic device 310 and may connect communication with wireless earphones 320. In this case, monitoring the external device 330 by the electronic device 310 may include identifying a location of the external device 330 by the electronic device 310 and registering information about the external device 330 to the electronic device 310 to connect communication. However, data transmission and reception may not be allowed between the electronic device 310 and the external device 330. The electronic device 310 may transmit target data to the wireless earphones 320 by connecting communication with the wireless earphones 320. In this case, the electronic device 310 may connect communication with the wireless earphones 320 through Bluetooth communication or wireless fidelity (Wi-Fi) communication. The external device 330 may monitor the electronic device 310 that may communicate with the external device 330 and the external device 330 and the wireless earphones 320 may monitor each other.

The electronic device 310 may periodically measure the first received signal strength power of the wireless earphones 320 with respect to the electronic device 310 and the number of first data transmissions from the electronic device 310 to the wireless earphones 320.

Referring to FIG. 4, when the first received signal strength power of the wireless earphones 320 with respect to the electronic device 310 decreases to the first threshold value or below or the number of first data transmissions of the electronic device 310 to the wireless earphones 320 increases to the first threshold number or above, the electronic device 310 may terminate the communication between the electronic device 310 and the wireless earphones 320 and may connect communication between the external device 330 and the wireless earphones 320. The received signal strength power of the wireless earphones with respect to the electronic device and the number of data transmissions from the electronic device to the wireless earphones may be factors to determine a communication state between the wireless earphones and the electronic device in which obstacles between the electronic device and the wireless earphones, an influence of other electronic devices using a frequency band similar to a frequency band (e.g., 2.4 GHz band) used by the wireless earphones, and the like are reflected. Hereinafter, the received signal strength power and the number of data transmissions are mainly described as factors used to determine a communication state, but are not limited thereto, and other factors for determining reception quality may be used to determine the communication state.

According to an embodiment of the disclosure, when the measured first received signal strength power decreases to a second threshold value, which is greater than the first threshold value, or below or the measured number of first data transmissions increases to a second threshold number, which is less than the first threshold number, or above, the electronic device may connect communication with the external device 330 and may transmit the target data to the external device 330. The electronic device 310 may connect communication with the external device 330 via Wi-Fi communication or Bluetooth communication. A difference between the second threshold value and the first threshold value may be between 2 dB and 3 dB, but is not limited thereto. A difference between the second threshold number and the first threshold number may be between 2 and 4, but is not limited thereto. As the communication between the electronic device 310 and the wireless earphones 320 gradually becomes unstable, the first received signal strength power of the wireless earphones 320 with respect to the electronic device 310 may gradually decrease and may reach the second threshold value or the number of first data transmissions from the electronic device 310 to the wireless earphones 320 may gradually increase and may reach the second threshold number. Reaching the second threshold value may include decreasing to the second threshold value or below and reaching the second threshold number may include increasing to the second threshold number or above. The electronic device 310 may connect the communication with the external device 330 before terminating the communication with the wireless earphones 320 to transmit, to the external device 330, the target data to be transmitted to the wireless earphones 320. In other words, the electronic device 310 may simultaneously transmit the target data to the wireless earphones 320 and the external device 330.

In addition, after connecting the communication with the external device 330, the electronic device 310 may terminate the communication with the wireless earphones 320 and after terminating the communication with the wireless earphones 320, the electronic device 310 may control the external device 330 to connect communication between the external device 330 and the wireless earphones 320. The electronic device 310 may transmit a control command to the external device 330 such that the external device 330 connects the communication with the wireless earphones 320.

The external device 330 may connect the communication with the wireless earphones 320 and may transmit the target data received from the electronic device 310 to the wireless earphones 320. The time of termination of communication between the electronic device 310 and the wireless earphones 320 may be different from the time of connection of communication between the external device 330 and the wireless earphones 320. The wireless earphones 320 may not receive the target data from the time of termination of communication with the electronic device 310 to the time of connection of communication with the external device 330. However, since the wireless earphones 320 store a portion of the target data received from the electronic device 310 in buffer memory, the wireless earphones 320 may play a seamless signal (e.g., an audio signal) by processing the portion of target data stored in the buffer memory from the time of termination of communication with the electronic device 310 to the time of connection of communication with the external device 330. The electronic device 310 may continuously monitor the wireless earphones 320 while terminating the communication with the wireless earphones 320 and may maintain the communication with the external device 330 to transmit the target data.

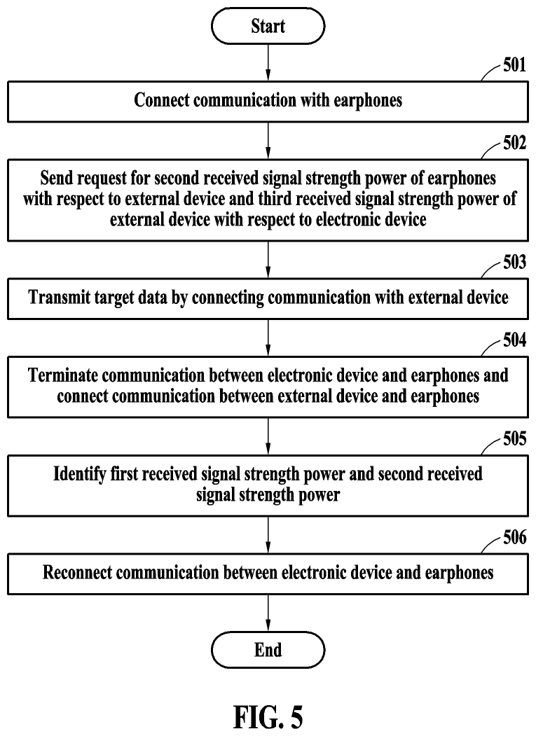

FIG. 5 is a flowchart illustrating a process of an electronic device to connect communication between an external device and wireless earphones and then reconnect communication between the electronic device and the wireless earphones, according to an embodiment of the disclosure.

Referring to FIG. 5, in operation 501, an electronic device (e.g., the electronic device 101 of FIG. 1) according to an embodiment may connect communication with wireless earphones. The electronic device may transmit, to the wireless earphones, target data to be used for audio playback.

In operation 502, when the first received signal strength power of the wireless earphones with respect to the electronic device decreases to a third threshold value, which is greater than the second threshold value, or below or the number of first data transmissions from the electronic device to the wireless earphones increases to a third threshold number, which is less than the second threshold number, or above, the electronic device may periodically send a request for second received signal strength power of the wireless earphones with respect to the external device and third received signal strength power of the external device with respect to the electronic device. For example, the electronic device may send a request to the external device or the wireless earphones for the second received signal strength power of the wireless earphones with respect to the external device and may send a request to the external device for the third received signal strength power of the external device with respect to the electronic device.

A difference between the third threshold value and the second threshold value may be between 2 dB and 3 dB, but is not limited thereto. A difference between the second threshold number and the first threshold number may be between 2 and 4, but is not limited thereto. For example, as the communication between the electronic device and the wireless earphones gradually becomes unstable, the first received signal strength power of the wireless earphones with respect to the electronic device may gradually decrease and may reach the third threshold value or the number of first data transmissions from the electronic device to the wireless earphones may gradually increase and may reach the third threshold number. Reaching the third threshold value may include decreasing to the third threshold value or below and reaching the third threshold number may include increasing to the third threshold number or above. In other words, the electronic device may periodically determine the second received signal strength power of the wireless earphones with respect to the external device and the third received signal strength power of the external device with respect to the electronic device before transmitting the target data to the external device.

According to an embodiment of the disclosure, when the first received signal strength power changes or the number of first data transmissions changes, the electronic device may stop sending the request for the second received signal strength power and the third received signal strength power. When the first received signal strength power exceeds the third threshold value and increases again and the number of first data transmissions decreases less than the third threshold number, the electronic device may stop sending the request for the second received signal strength power of the wireless earphones with respect to the external device and the third received signal strength power of the external device with respect to the electronic device.

In operation 503, when the first received signal strength power of the wireless earphones with respect to the electronic device decreases to the second threshold value, which is greater than the first threshold value, or below or the number of first data transmissions from the electronic device to the wireless earphones increases to the second threshold number, which is less than the first threshold number, or above, the electronic device may connect communication with the external device and may transmit the target data to the external device.

According to an embodiment of the disclosure, the electronic device may connect the communication with the external device via Bluetooth communication or Wi-Fi communication and may transmit the target data to the external device. Typically, since a Bluetooth antenna disposed in the electronic may be significantly affected in terms of performance by an electronic device grip type (e.g., death grip) of a user and a position in which the electronic device is disposed, the electronic device may connect the communication with the external device via Wi-Fi communication using a Wi-Fi antenna disposed in the electronic device. For example, the electronic device may transmit the target data to the external device in a short time via 2.4 GHZ Wi-Fi or 5 GHz Wi-Fi of a broadband with excellent transmission control protocol (TCP) speed. For reference, since up to three or four Wi-Fi antennas may be disposed in the electronic device, the electronic device may be relatively less affected by the electronic device grip type of the user and the position in which the electronic device is disposed compared to the Bluetooth antenna. The external device may store the target data received from the electronic device in buffer memory.

According to an embodiment of the disclosure, when the first received signal strength power changes or the number of first data transmissions changes while the electronic device transmits the target data to the external device, the electronic device may stop transmitting the target data to the external device. For example, when the first received signal strength power exceeds the second threshold value and increases again and the number of first data transmissions decreases less than the second threshold number, the electronic device may terminate the communication with the external device and may stop transmitting the target data to the external device. Furthermore, when the first received signal strength power exceeds the third threshold value and increases and the number of first data transmissions decreases less than the third threshold number, the electronic device may also stop sending the request for the second received signal strength power of the wireless earphones with respect to the external device and the third received signal strength power of the external device with respect to the electronic device.

In operation 504, when the first received signal strength power of the wireless earphones with respect to the electronic device decreases to the first threshold value or below or the number of first data transmissions increases to the first threshold number or above, the electronic device may terminate the communication between the electronic device and the wireless earphones and may control the external device to connect communication between the external device and the wireless earphones. The electronic device may control the external device to transmit the target data to the wireless earphones. The wireless earphones may receive the target data from the external device and may play a signal corresponding to the target data.

According to an embodiment of the disclosure, the electronic device may determine whether to terminate the communication between the electronic device and the wireless earphones and connect the communication between the external device and the wireless earphones by additionally considering the second received signal strength power of the wireless earphones with respect to the external device and the third received signal strength power of the external device with respect to the electronic device. According to an embodiment of the disclosure, the electronic device may determine whether to connect the communication between the external device and the wireless earphones based on a comparison between the first received signal strength power and the second received signal strength power and a comparison between the third received signal strength power and a threshold value. For example, when the second received signal strength power of the wireless earphones with respect to the external device is greater than the first received signal strength power of the wireless earphones with respect to the electronic device and the third received signal strength power is greater than the threshold value, the electronic device may determine to connect the communication between the external device and the wireless earphones. In this case, the threshold value may be the minimum received signal strength power required to smoothly transmit data to the external device by the electronic device and may be a predetermined value by the electronic device. In other words, the electronic device may determine whether to connect the communication between the external device and the wireless earphones by determining whether an electric field condition between the external device and the wireless earphones is better than an electric field condition between the electronic device and the wireless earphones and whether the electronic device is able to smoothly transmit the target data to the external device. In other words, even when the first received signal strength power decreases to the first threshold value or below or the number of first data transmissions increases to the first threshold number or above, if the second received signal strength power is greater than the first received signal strength power and the third received signal strength power is greater than the threshold value, the electronic device may connect the communication between the external device and the wireless earphones.

In operation 505, the electronic device may monitor the wireless earphones even after terminating the communication with the wireless earphones and may identify the first received signal strength power of the wireless earphones with respect to the electronic device by sending a request to the wireless earphones. In addition, even after terminating the communication with the wireless earphones, the electronic device may identify the second received signal strength power of the wireless earphones with respect to the external device by sending a request to the wireless earphones. In other words, the electronic device may continuously identify the first received signal strength power and the second received signal strength power.

In operation 506, as the communication between the electronic device and the wireless earphones becomes stable again, the electronic device may terminate the communication between the external device and the wireless earphones and may reconnect the communication between the electronic device and the wireless earphones.

According to an embodiment of the disclosure, the electronic device may determine whether to reconnect the communication between the electronic device and the wireless earphones based on the first received signal strength power of the wireless earphones with respect to the electronic device and the second received signal strength power of the wireless earphones with respect to the external device. According to an embodiment of the disclosure, when the first received signal strength power increases to the second threshold value or above and the first received signal strength power exceeds the second received signal strength power while the communication between the external device and the wireless earphones is connected, the electronic device may terminate the communication between the external device and the wireless earphones and may reconnect the communication between the electronic device and the wireless earphones to directly transmit the target data to the wireless earphones.

According to an embodiment of the disclosure, the electronic device may determine a time of termination of the communication between the external device and the wireless earphones based on data buffered to the wireless earphones. According to an embodiment of the disclosure, when a size of the data buffered to the wireless earphones of the target data is greater than or equal to a threshold data size, the electronic device may control the external device to terminate the communication between the external device and the wireless earphones. For example, since a time interval exists as the time of termination of communication connection between the wireless earphones and the external device is different from the time of connection of communication between the wireless earphones and the electronic device, a predetermined volume of data to be processed by the wireless earphones may be required to play a seamless signal by the wireless earphones while a device connected to the wireless earphones changes. Accordingly, to play a seamless signal by processing the buffered data while the wireless earphones switch the communication, the electronic device may terminate the communication between the external device and the wireless earphones at a time point at which the size of data buffered to the wireless earphones is greater than or equal to a second threshold data size and thereafter, the electronic device may connect the communication with the wireless earphones.

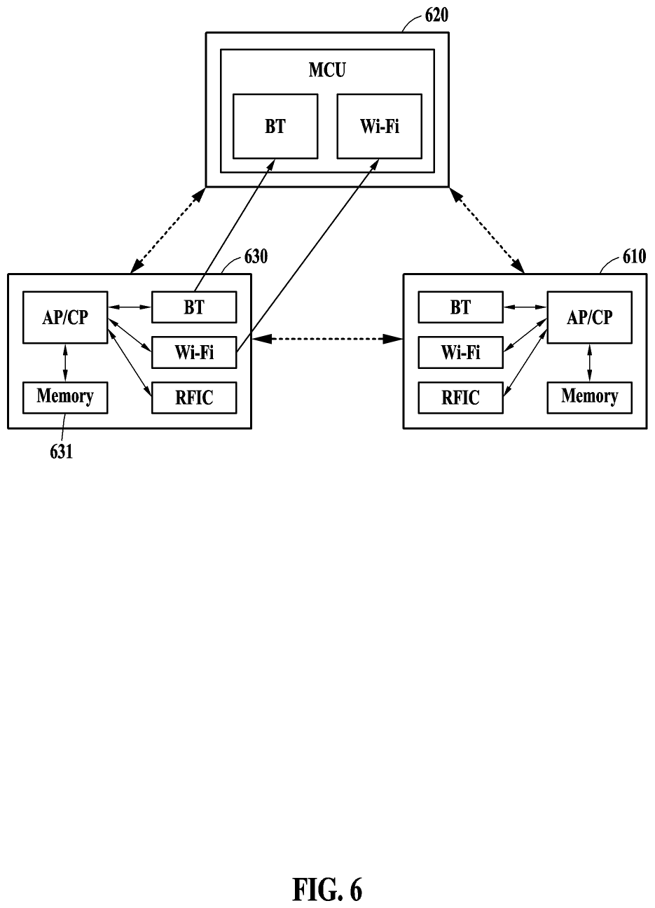

FIG. 6 is a diagram illustrating communication connection among an electronic device, an external device, and wireless earphones according to an embodiment of the disclosure.

Referring to FIG. 6, an electronic device 610, wireless earphones 620, and an external device 630 may monitor each other. Firstly, when first received signal strength power of the wireless earphones 620 with respect to the electronic device 610 decreases to a second threshold value or below or the number of first data transmissions from the electronic device 610 to the wireless earphones 620 increases to a second threshold number or above, the electronic device 610 may connect communication with the external device 630 and may transmit target data to the external device 630. Referring to FIG. 6, the electronic device 610 may connect the communication with the external device via Wi-Fi communication and may transmit the target data to the external device 630 via Wi-Fi communication. However, the example is not limited thereto and the electronic device 610 may be connected to the external device 630 via Bluetooth communication. The external device 630 may store the target data received from the electronic device 610 in memory 631 (e.g., buffer memory).

In addition, when the first received signal strength power decreases to a first threshold value or below or the number of first data transmissions increases to a first threshold number or above, the electronic device 610 may terminate the communication between the electronic device 610 and the wireless earphones 620 and may connect the communication between the external device 630 and the wireless earphones 620. Referring to FIG. 6, the external device 630 may connect the communication with the wireless earphones 620 via Bluetooth communication or Wi-Fi communication. For example, the external device 630 may transmit the target data to the wireless earphones 620 via Bluetooth communication, and the external device 630 may transmit the target data to the wireless earphones 620 via Wi-Fi communication. Hereinafter, a time point at which the electronic device 610 terminates the communication with the wireless earphones 620 is described.

According to an embodiment of the disclosure, among data of the target data buffered to the external device, after a time point at which a size of the data except for a portion of the data processed by the wireless earphones is greater than a first threshold data size, the electronic device may terminate the communication between the electronic device and the wireless earphones. The external device may transmit the target data by connecting the communication with the wireless earphones before receiving all target data from the electronic device. Accordingly, to play a seamless signal by the wireless earphones, among the target data, data other than the data processed by the wireless earphones may need to be secured in the external device. Accordingly, among the data buffered to the external device, after the time point at which the size of the data except for the portion of the data processed by the wireless earphones is greater than the first threshold data size, the electronic device may terminate the communication between the electronic device and the wireless earphones to connect the communication between the external device and the wireless earphones.

According to an embodiment of the disclosure, among the target data, after a time point at which a size of data buffered to the wireless earphones 620 is greater than a second threshold data size, the electronic device may terminate the communication between the electronic device and the wireless earphones. When the wireless earphones switch the communication from the electronic device to the external device, the time point of termination of communication connection between the wireless earphones and the electronic device may be different from the time point of connection of communication between the wireless earphones and the electronic device. Accordingly, to play a seamless signal by the wireless earphones, a predetermined volume of data to be processed by the wireless earphones may be required to play the seamless signal by the wireless earphones while a device connected to the wireless earphones changes. Accordingly, to play the seamless signal by processing the buffered data while the wireless earphones switch the communication, the electronic device may terminate the communication between the electronic device and the wireless earphones after a time point at which the size of data buffered to the wireless earphones among the target data is greater than the second threshold data size and thereafter, the electronic device may control the external device to connect the communication between the external device and the wireless earphones.

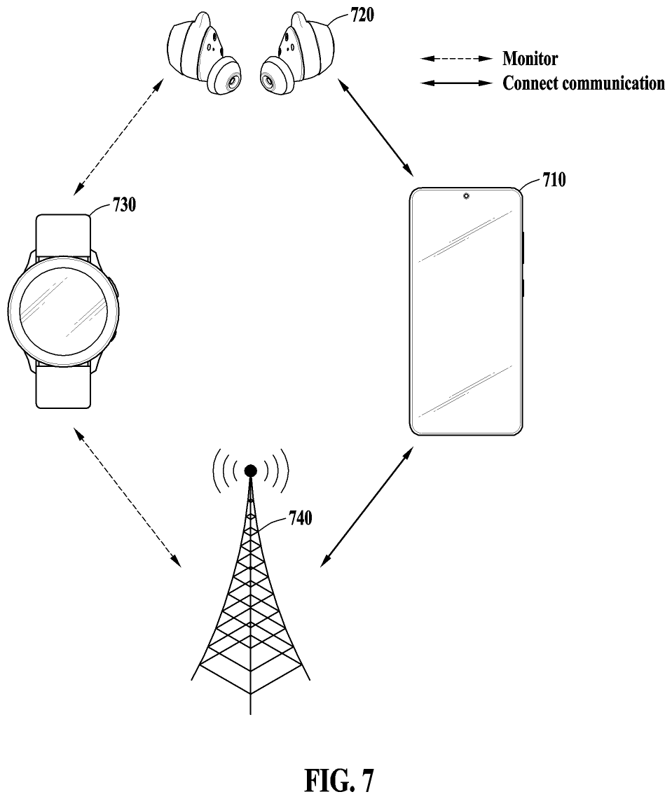

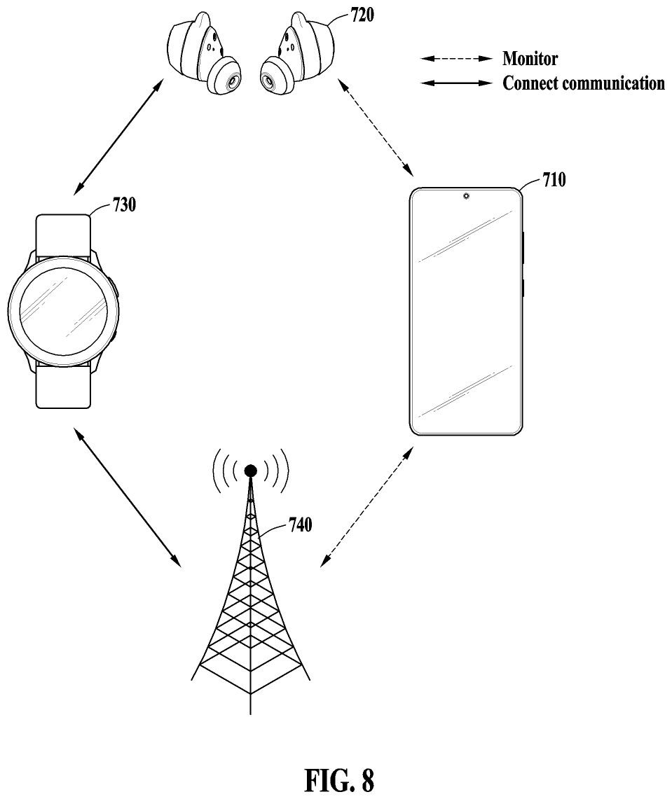

FIGS. 7 and 8 are diagrams illustrating a process of an electronic device to terminate communication between the electronic device and wireless earphones and connect communication between an external device and wireless earphones such that the external device receives real-time data from a network and transmits the real-time data to the wireless earphones, according to various embodiments of the disclosure.

Referring to FIGS. 7 and 8, according to an embodiment of the disclosure, an electronic device 710 (e.g., the electronic device 101 of FIG. 1) may connect communication with an external network 740. The electronic device 710 may directly connect the communication with the external network 740 or may connect the communication with the external network 740 via an access point (AP). In other words, connecting the communication with the external network 740 by the electronic device 710 may include connecting the communication with an AP. As described below, terminating the communication with the external network 740 by the electronic device 710 may include terminating the communication with the AP.

The electronic device 710 may connect communication with wireless earphones 720. The electronic device 710 may receive real-time data from the external network 740 and may transmit the received real-time data to the wireless earphones 720. For example, the electronic device 710 may allow a user to use a real-time music streaming service or a call function through the wireless earphones 720 by transmitting, to the wireless earphones 720, the real-time data received from the external network 740. An external device 730 disposed around the electronic device 710 and the wireless earphones 720 may monitor each other and the external device 730 and the external network 740 may monitor each other. According to an embodiment of the disclosure, the electronic device 710 may periodically measure fourth received signal strength power of the electronic device 710 with respect to the external network 740 and the number of second data transmissions from the external network 740 to the electronic device 710.

Referring to FIG. 8, when the fourth received signal strength power of the electronic device 710 with respect to the external network 740 decreases to a fourth threshold value or below or the number of second data transmissions from the external network 740 to the electronic device 710 increases to a fourth threshold number or above, the electronic device 710 may terminate the communication between the electronic device 710 and the wireless earphones 720 and may control the external device 730 to connect the communication between the external device 730 and the external network 740 and the communication between the external device 730 and the wireless earphones 720 such that the wireless earphones 720 receive the real-time data from the external device 730. The electronic device 710 may terminate the communication with the external network 740 while terminating the communication between the electronic device 710 and the wireless earphones 720. In other words, as the communication between the electronic device 710 and the external network 740 becomes unstable, the electronic device 710 may control the external device 730 to transmit the real-time data to the wireless earphones 720 via the external network 740 instead of the electronic device 710. After terminating the communication with the external network 740, the electronic device 710 may monitor the external network 740 and after terminating the communication with the wireless earphones 720, the electronic device 710 may monitor the wireless earphones 720.

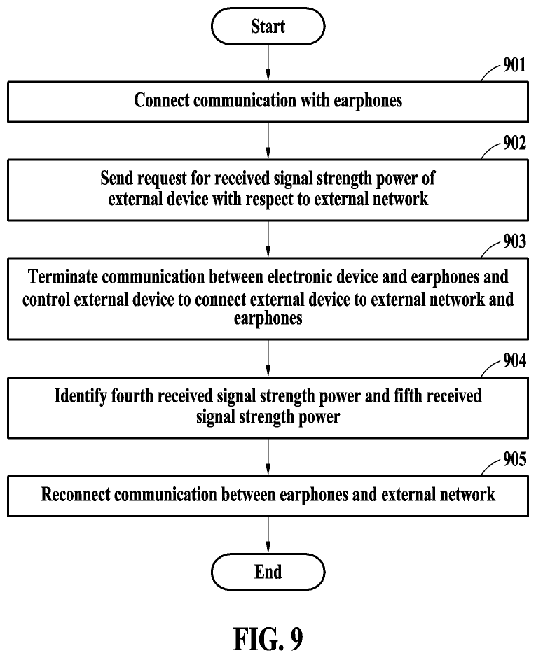

FIG. 9 is a flowchart illustrating a process of an electronic device to connect communication between an external device and an external network and then reconnect communication between the electronic device and the external network, according to an embodiment of the disclosure.

Referring to FIG. 9, in operation 901, an electronic device (e.g., the electronic device 101 of FIG. 1) according to an embodiment may connect communication with wireless earphones. The electronic device may transmit, to the wireless earphones, target data to be used for audio playback.

In operation 902, when the fourth received signal strength power of the electronic device with respect to the external network decreases to a fifth threshold value, which is greater than the fourth threshold value, or below or the number of second data transmissions from the external network to the electronic device increases to a fifth threshold number, which is less than the fourth threshold number, or above, the electronic device may send a request for fifth received signal strength power of the external device with respect to the external network. A difference between the fifth threshold value and the fourth threshold value may be between 2 dB and 3 dB, but is not limited thereto. A difference between the fifth threshold number and the fourth threshold number may be between 2 and 4, but is not limited thereto. For example, as the communication between the electronic device and the external network gradually becomes unstable, the fourth received signal strength power of the electronic device with respect to the external network may gradually decrease and may reach the fifth threshold value or the number of second data transmissions from the external network to the electronic device may gradually increase and may reach the fifth threshold number. In other words, the electronic device may periodically identify the fifth received signal strength power of the external device with respect to the external network before connecting the external device to the wireless earphones.

In operation 903, when the fourth received signal strength power of the electronic device with respect to the external network decreases to the fourth threshold value or below or the number of second data transmissions from the external network to the electronic device increases to the fourth threshold number or above, the electronic device may control the external device to connect communications with the external network and the wireless earphones, respectively.

According to an embodiment of the disclosure, the electronic device may determine whether to terminate the communication between the electronic device and the wireless earphones and connect the communication between the external device and the external network and the communication between the external device and the wireless earphones by additionally considering the fifth received signal strength power of the external device with respect to the external network. According to an embodiment of the disclosure, the electronic device may determine whether to connect the communication between the external device and the external network and the communication between the external device and the wireless earphones based on a comparison between the fourth received signal strength power of the electronic device with respect to the external network and the fifth received signal strength power of the external device with respect to the external network. For example, when the fifth received signal strength power of the external device with respect to the external network is greater than the fourth received signal strength power of the electronic device with respect to the external network, the electronic device may determine whether to connect the communications between the external device and the external network and between the external device and the wireless earphones. In other words, the electronic device may determine whether to connect the communications between the external device and the external network and between the external device and the wireless earphones by determining whether an electric field condition between the external device and the external network is better than an electric field condition between the electronic device and the external network.

According to an embodiment of the disclosure, the electronic device may determine whether to terminate the communication between the electronic device and the wireless earphones and connect the communication between the external device and the external network and the communication between the external device and the wireless earphones by additionally considering the second received signal strength power of the wireless earphones with respect to the external device. According to an embodiment of the disclosure, when the second received signal strength power of the wireless earphones with respect to the external device is greater than a threshold value, which is the minimum received signal strength power required to transmit data to the wireless earphones by the external device, the electronic device may connect the communication between the external device and the external network and between the external device and the wireless earphones.

In operation 904, even after terminating the communication between the electronic device and the wireless earphones, the electronic device may measure the fourth received signal strength power of the electronic device with respect to the external network and may identify the fifth received signal strength power of the external device with respect to the external network by sending a request to the external device.

In operation 905, as the communication between the electronic device and the external network becomes stable again, the electronic device may terminate the communication connection between the external device and the wireless earphones and may reconnect the communications between the electronic device and the external network and between the electronic device and the wireless earphones.

According to an embodiment of the disclosure, the electronic device may determine whether to reconnect the communication between the electronic device and the wireless earphones and the communication between the electronic device and the external network based on the fourth received signal strength power of the electronic device with respect to the external network and the fifth received signal strength power of the external device with respect to the external network. According to an embodiment of the disclosure, when the fourth received signal strength power exceeds the fifth received signal strength power while the communication between the external device and the wireless earphones and the communication between the external device and the external network are connected, the electronic device may control the external device to terminate the communication between the external device and the wireless earphones and the communication between the external device and the external network and may directly transmit the real-time data to the wireless earphones by reconnecting the communications between the electronic device and the wireless earphones and between the electronic device and the external network.

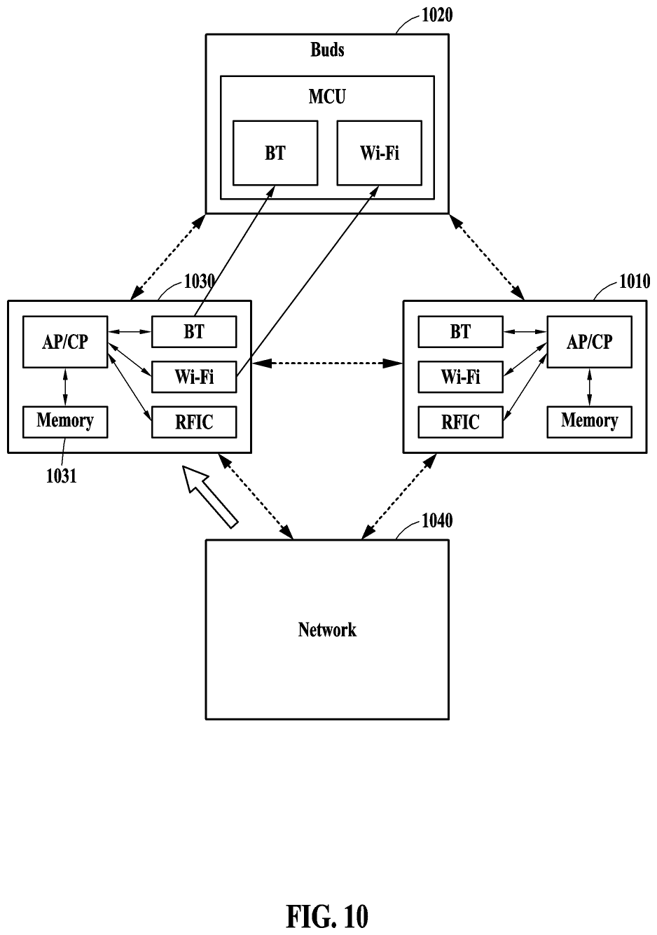

FIG. 10 is a diagram illustrating communication connection among an electronic device, an external device, wireless earphones, and a network according to an embodiment of the disclosure.

Referring to FIG. 10, an electronic device 1010, wireless earphones 1020, an external device 1030, and an external network 1040 may monitor each other. Firstly, when the fourth received signal strength power of the electronic device 1010 with respect to the external network 1040 decreases to the fourth threshold value or below or the number of second data transmissions from the external network 1040 to the electronic device 1010 increases to the fourth threshold number or above, the electronic device 1010 may terminate communication between the electronic device 1010 and the wireless earphones 1020 and may connect communication between the external device 1030 and the wireless earphones and communication between the external device 1030 and the external network 1040. Referring to FIG. 10, the external device 1030 may connect the communication with the wireless earphones 1020 via Bluetooth communication or Wi-Fi communication. The external device 1030 may receive real-time data from the external network 1040 by connecting the communication with the external network 1040 and may store the received real-time data in memory 1031 (e.g., buffer memory). In addition, the external device 1030 may transmit the real-time data stored in the memory 1031 to the wireless earphones 1020.

According to an embodiment of the disclosure, an electronic device may include a communicator configured to connect communication with wireless earphones, memory configured to store at least one instruction, and a processor configured to execute the instructions stored in the memory, wherein the processor may be configured to periodically measure a first received signal strength power of the wireless earphones with respect to the electronic device and the number of first data transmissions from the electronic device to the wireless earphones, transmit, to an external device, target data to be transmitted to the wireless earphones, when the measured first received signal strength power decreases to a first threshold value or below or the measured number of first data transmissions increases to a first threshold number or above, terminate communication between the electronic device and the wireless earphones and control the external device to connect communication between the external device and the wireless earphones such that the wireless earphones receive the target data from the external device.

The processor may be configured to, when the measured first received signal strength power decreases to a second threshold value, which is greater than the first threshold value, or below or the measured number of first data transmissions increases to a second threshold number, which is less than the first threshold number, or above, transmit the target data to the external device by connecting communication with the external device.

The communicator may be configured to transmit the target data to the external device by connecting the communication with the external device via Bluetooth communication or Wi-Fi communication.

The processor may be configured to, when the measured first received signal strength power decreases to a third threshold value, which is greater than the second threshold value, or below or the measured number of first data transmissions increases to a third threshold number, which is less than the second threshold number, or above, send a request for second received signal strength power of the wireless earphones with respect to the external device and third received signal strength power of the external device with respect to the electronic device.

The processor may be configured to determine whether to connect the communication between the external device and the wireless earphones based on a comparison between the measured first received signal strength power and the measured second received signal strength power and a comparison between the third received signal strength power and a threshold value.

The processor may be configured to terminate the communication between the electronic device and the wireless earphones after a time point at which among data buffered to the external device of the target data, a size of the data except for a portion of the data processed by the wireless earphones is greater than a first threshold data size.

The processor may be configured to terminate the communication between the electronic device and the wireless earphones after a time point at which a size of data buffered to the wireless earphones among the target data is greater than a second threshold data size.

The processor may be configured to, while the communication between the external device and the wireless earphones is connected, when the measured first received signal strength power increases to the second threshold value or above and the measured first received signal strength power exceeds the measured second received signal strength power, control the external device to terminate the communication between the external device and the wireless earphones and directly transmit the target data to the wireless earphones by reconnecting the communication between the electronic device and the wireless earphones.

According to an embodiment of the disclosure, an electronic device may include a communicator configured to receive real-time data from an external network and transmit the real-time data to wireless earphones, memory configured to store at least one instruction, and a processor configured to execute the instructions stored in the memory, wherein the processor may be configured to periodically measure fourth received signal strength power of the electronic device with respect to the external network and the number of second data transmissions from the external network to the electronic device, and when the measured fourth received signal strength power decreases to a fourth threshold value or below or the measured number of second data transmissions increases to a fourth threshold number or above, terminate communication between the electronic device and the wireless earphones and control an external device to connect communication between the external device and the external network and communication between the external device and the wireless earphones such that the wireless earphones receive real-time data from the external device.

The processor may be configured to send a request for fifth received signal strength power of the external device with respect to the external network, and determine whether to connect the communication between the external device and the network and the communication between the external network and the wireless earphones based on a comparison between the measured fourth received signal strength power and the measured fifth received signal strength power.

According to an embodiment of the disclosure, a method, performed by a processor, may include periodically measuring first received signal strength power of wireless earphones, in which communication with an electronic device is established, to the electronic device and the number of first data transmissions from the electronic device to the wireless earphones, transmitting, to an external device, target data to be transmitted to the wireless earphones, and when the measured first received signal strength power decreases to a first threshold value or below or the measured number of first data transmissions increases to a first threshold number or above, terminating communication between the electronic device and the wireless earphones and controlling the external device to connect communication between the external device and the wireless earphones such that the wireless earphones receive the target data from the external device.

The transmitting of the target data to the external device may include, when the measured first received signal strength power decreases to a second threshold value, which is greater than the first threshold value, or below or the measured number of first data transmissions increases to a second threshold number, which is less than the first threshold number, or above, transmitting the target data to the external device by connecting communication with the external device.

The transmitting of the target data to the external device may include transmitting the target data to the external device by connecting the communication with the external device via Bluetooth communication or Wi-Fi communication.

The method may further include, when the measured first received signal strength power decreases to a third threshold value, which is greater than the second threshold value, or below or the measured number of first data transmissions increases to a third threshold number, which is less than the second threshold number, or above, sending a request for second received signal strength power of the wireless earphones with respect to the external device and third received signal strength power of the external device with respect to the electronic device.

The connecting of the communication between the external device and the wireless earphones may include determining whether to connect the communication between the external device and the wireless earphones based on a comparison between the measured first received signal strength power and the measured second received signal strength power and a comparison between the third received signal strength power and a threshold value.

The connecting of the communication between the external device and the wireless earphones may include terminating the communication between the electronic device and the wireless earphones after a time point at which among data buffered to the external device of the target data, a size of the data except for a portion of the data processed by the wireless earphones is greater than a first threshold data size.

The connecting of the communication between the external device and the wireless earphones may include terminating the communication between the external device and the wireless earphones after a time point at which a size of data buffered to the wireless earphones among the target data is greater than a second threshold data size.

The method may further include, while the communication between the external device and the wireless earphones is connected, when the measured first received signal strength power increases to the second threshold value or above and the measured first received signal strength power exceeds the measured second received signal strength power, controlling the external device to terminate the communication between the external device and the wireless earphones and directly transmitting the target data to the wireless earphones by reconnecting the communication between the electronic device and the wireless earphones.

According to an embodiment of the disclosure, a method, performed by a processor, may include receiving real-time data from an external network and transmitting the real-time data to wireless earphones, periodically measuring fourth received signal strength power of an electronic device to the external network and the number of second data transmissions from the external network to the electronic device, and when the measured fourth received signal strength power decreases to a fourth threshold value or below or the measured number of second data transmissions increases to a fourth threshold number or above, terminating communication between the electronic device and the wireless earphones and controlling an external device to connect communication between the external device and the external network and communication between the external device and the wireless earphones such that the wireless earphones receive real-time data from the external device.

The method may further include sending a request for fifth received signal strength power of the external device with respect to the external network, wherein the connecting of the communication between the external device and the external network and the communication between the external device and the wireless earphones may include determining whether to connect the communication between the external device and the network and the communication between the external device and the wireless earphones based on a comparison between the measured fourth received signal strength power and the measured fifth received signal strength power.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communicator configured to establish communication with wireless earphones;
memory storing one or more computer programs; and
a processor communicatively coupled to the communicator and the memory,
wherein the one or more computer programs include computer-executable instructions that, when executed by the processor individually or collectively, cause the electronic device to:
periodically measure a first received signal strength power of the wireless earphones with respect to the electronic device and a number of first data transmissions from the electronic device to the wireless earphones,
transmit, to an external device, target data to be transmitted to the wireless earphones, and
when the measured first received signal strength power decreases to a first threshold value or below or a measured number of first data transmissions increases to a first threshold number or above, terminate communication between the electronic device and the wireless earphones and control the external device to establish communication between the external device and the wireless earphones such that the wireless earphones receive the target data from the external device.

2. The electronic device of claim 1,
wherein the one or more computer programs further include computer-executable instructions that, when executed by the processor individually or collectively, cause the electronic device to:
when the measured first received signal strength power decreases to a second threshold value, which is greater than the first threshold value, or below or the measured number of first data transmissions increases to a second threshold number, which is less than the first threshold number, or above, transmit the target data to the external device by connecting communication with the external device.

3. The electronic device of claim 2, wherein the communicator is configured to:
transmit the target data to the external device by connecting the communication with the external device via Bluetooth communication or wireless fidelity (Wi-Fi) communication.

4. The electronic device of claim 3, wherein the one or more computer programs further include computer-executable instructions that, when executed by the processor individually or collectively, cause the electronic device to:
when the measured first received signal strength power decreases to a third threshold value, which is greater than the second threshold value, or below or the measured number of first data transmissions increases to a third threshold number, which is less than the second threshold number, or above, send a request for second received signal strength power of the wireless earphones with respect to the external device and third received signal strength power of the external device with respect to the electronic device.

5. The electronic device of claim 4, wherein the one or more computer programs further include computer-executable instructions that, when executed by the processor individually or collectively, cause the electronic device to:
determine whether to connect the communication between the external device and the wireless earphones based on a comparison between the measured first received signal strength power and a measured second received signal strength power and a comparison between the third received signal strength power and a threshold value.

6. The electronic device of claim 5, wherein the one or more computer programs further include computer-executable instructions that, when executed by the processor individually or collectively, cause the electronic device to:
terminate the communication between the electronic device and the wireless earphones after a time point at which among data buffered to the external device of the target data, a size of the data except for a portion of the data processed by the wireless earphones is greater than a first threshold data size.

7. The electronic device of claim 6, wherein the one or more computer programs further include computer-executable instructions that, when executed by the processor individually or collectively, cause the electronic device to:
terminate the communication between the electronic device and the wireless earphones after a time point at which a size of data buffered to the wireless earphones among the target data is greater than a second threshold data size.

8. The electronic device of claim 7, wherein the one or more computer programs further include computer-executable instructions that, when executed by the processor individually or collectively, cause the electronic device to:
while the communication between the external device and the wireless earphones is connected, when the measured first received signal strength power increases to the second threshold value or above and the measured first received signal strength power exceeds the measured second received signal strength power, control the external device to terminate the communication between the external device and the wireless earphones and directly transmit the target data to the wireless earphones by reconnecting the communication between the electronic device and the wireless earphones.

9. An electronic device comprising:
a communicator configured to receive real-time data from an external network and transmit the real-time data to wireless earphones;
memory storing one or more computer programs; and
a processor communicatively coupled to the communicator and the memory,
wherein the one or more computer programs include computer-executable instructions that, when executed by the processor individually or collectively, cause the electronic device to:
periodically measure fourth received signal strength power of the electronic device with respect to the external network and a number of second data transmissions from the external network to the electronic device, and
when the measured fourth received signal strength power decreases to a fourth threshold value or below or a measured number of second data transmissions increases to a fourth threshold number or above, terminate communication between the electronic device and the wireless earphones and control an external device to establish communication between the external device and the external network and communication between the external device and the wireless earphones such that the wireless earphones receive real-time data from the external device.

10. The electronic device of claim 9, wherein the one or more computer programs further include computer-executable instructions that, when executed by the processor individually or collectively, cause the electronic device to:
send a request for fifth received signal strength power of the external device with respect to the external network; and
determine whether to connect the communication between the external device and the network and the communication between the external network and the wireless earphones based on a comparison between the measured fourth received signal strength power and a measured fifth received signal strength power.

11. A method performed by a processor, the method comprising:
periodically measuring first received signal strength power of wireless earphones, in which communication with an electronic device is established, to the electronic device and a number of first data transmissions from the electronic device to the wireless earphones;
transmitting, to an external device, target data to be transmitted to the wireless earphones; and
when the measured first received signal strength power decreases to a first threshold value or below or a measured number of first data transmissions increases to a first threshold number or above, terminating communication between the electronic device and the wireless earphones and controlling the external device to establish communication between the external device and the wireless earphones such that the wireless earphones receive the target data from the external device.

12. The method of claim 11, wherein the transmitting of the target data to the external device comprises:
when the measured first received signal strength power decreases to a second threshold value, which is greater than the first threshold value, or below or the measured number of first data transmissions increases to a second threshold number, which is less than the first threshold number, or above, transmitting the target data to the external device by connecting communication with the external device.

13. The method of claim 12, further comprising:
when the measured first received signal strength power decreases to a third threshold value, which is greater than the second threshold value, or below or the measured number of first data transmissions increases to a third threshold number, which is less than the second threshold number, or above, sending a request for second received signal strength power of the wireless earphones with respect to the external device and third received signal strength power of the external device with respect to the electronic device.

14. The method of claim 13, wherein the connecting of the communication between the external device and the wireless earphones comprises:
determining whether to connect the communication between the external device and the wireless earphones based on a comparison between the measured first received signal strength power and a measured second received signal strength power and a comparison between the third received signal strength power and a threshold value.

15. A method performed by a processor, the method comprising:
receiving real-time data from an external network and transmitting the real-time data to wireless earphones;
periodically measuring fourth received signal strength power of an electronic device to the external network and a number of second data transmissions from the external network to the electronic device; and
when the measured fourth received signal strength power decreases to a fourth threshold value or below or a measured number of second data transmissions increases to a fourth threshold number or above, terminating communication between the electronic device and the wireless earphones and controlling an external device to establish communication between the external device and the external network and communication between the external device and the wireless earphones such that the wireless earphones receive real-time data from the external device.

16. The method of claim 15, wherein the transmitting of target data to the external device comprises:
when the measured first received signal strength power decreases to a second threshold value, which is greater than a first threshold value, or below or a measured number of first data transmissions increases to a second threshold number, which is less than a first threshold number, or above, transmitting the target data to the external device by connecting communication with the external device.

17. The method of claim 16, further comprising:
when the measured first received signal strength power decreases to a third threshold value, which is greater than the second threshold value, or below or the measured number of first data transmissions increases to a third threshold number, which is less than the second threshold number, or above, sending a request for second received signal strength power of the wireless earphones with respect to the external device and third received signal strength power of the external device with respect to the electronic device.

18. The method of claim 17, wherein the connecting of the communication between the external device and the wireless earphones comprises:
determining whether to connect the communication between the external device and the wireless earphones based on a comparison between the measured first received signal strength power and a measured second received signal strength power and a comparison between the third received signal strength power and a threshold value.

19. One or more non-transitory computer-readable storage media storing computer-executable instructions that, when executed by a processor individually or collectively, cause the processor to perform operations, the operations comprising:
periodically measuring first received signal strength power of wireless earphones, in which communication with an electronic device is established, to the electronic device and a number of first data transmissions from the electronic device to the wireless earphones;
transmitting, to an external device, target data to be transmitted to the wireless earphones; and
when the measured first received signal strength power decreases to a first threshold value or below or a measured number of first data transmissions increases to a first threshold number or above, terminating communication between the electronic device and the wireless earphones and controlling the external device to establish communication between the external device and the wireless earphones such that the wireless earphones receive the target data from the external device.

20. The one or more non-transitory computer-readable storage media of claim 19, wherein the transmitting of the target data to the external device comprises:
when the measured first received signal strength power decreases to a second threshold value, which is greater than the first threshold value, or below or the measured number of first data transmissions increases to a second threshold number, which is less than the first threshold number, or above, transmitting the target data to the external device by connecting communication with the external device.
